(19) United States
(12) Patent Application Publication
(10) Pub. No.: US 2003/0226709 A1
(43) Pub. Date: Dec. 11, 2003

(54) EPAS assembly with motion conversion sleeve

(76) Inventors: Edward Taylor Fowlkes, Northville, MI (US); Edward Francis McElmeel JR., Milan, MI (US); Michael James Kostrzewa, Grosse Pointe Woods, MI (US)

Correspondence Address: Thomas E. Donohue, Artz & Artz, P.C., Suite 250, 28333 Telegraph Road, Southfield, MI, 48034, US

(21) Appl. No.: 10/164,470

(22) Filed: Jun. 6, 2002

(51) Int. Cl. B62D 5/04

(52) U.S. Cl. 180/443

(57) ABSTRACT

An EPAS assembly 10 is provided, including a steering input shaft 16 and a pinion shaft 18. The steering input shaft 16 includes at least input shaft pin 36 and the pinion shaft 18 includes at least one pinion pin 38. The pins 36, 38 reside respectively within at least one helical slot 32 and at least one axial slot 34 formed within a sleeve element 28. The sleeve element 28 translates differences in rotation between the steering input shaft 16 and the pinion shaft 18 into linear motion. A torque sensor 20 registers the linear motion of the sleeve element 28 and uses it to control power assist to the pinion shaft 18.

### TECHNICAL FIELD

The present invention relates generally to an EPAS assembly and more particularly to an EPAS assembly including a sleeve for converting rotary motion to linear motion.

### BACKGROUND OF THE INVENTION

Present automotive designs commonly incorporate power assisted steering. Typical power assisted steering systems utilize hydraulic pumps driven by the engine crank shaft. The steering system incorporates a control valve sensitive to the driver input force which when paired with the hydraulic system reduces the effort required to steer the vehicle. Hydraulic systems, unfortunately, can be inefficient and can tax engine power. This can result in an undesirable increase in fuel consumption as well as an undesirable reduction of vehicle performance. These as well as other deficiencies associated with hydraulic based power steering systems have driven engineers and designers to search for viable alternatives.

One alternative has been the development of electrically power assisted steering (also known as EPAS). Conventional EPAS systems utilize a torque sensor in communication with the steering column. The torque sensor communicates with the servo motor and control electronics. When the driver turns the steering column, the servo motor assists in turning of the steering gear in response to driver torque sensed by the torque sensor. This, in turn, reduces the force the driver need exert on the steering column.

A significant advantage presented by EPAS systems is the ability to improve a vehicle's fuel economy. The improvement of fuel economy is a benefit long recognized by the automotive industry. In addition, automotive performance can be improved since these power assisted steering systems no longer provide a physical drain on the engine crankshaft. This, in turn, can provide increased customer satisfaction with the vehicle purchase. Finally, EPAS systems can be designed and implemented in embodiments that can be significantly smaller than their equivalent hydraulic counterparts. Their smaller profile can increase the useful space within the engine compartment, thereby providing an added benefit to designers and manufacturers.

Although present EPAS systems provide these and a variety of other benefits to automotive steering design, they can also incorporate undesirable design elements. Once such negative design element arises in the area of communication between the steering column and the torque sensor. Complex gearing arrangements have been utilized, but these solutions are often bulky and expensive to manufacture. Additionally, many current designs result in undesirable frictional losses in the communication between the steering column and torque sensor. Thus, the present state of EPAS steering designs leaves considerable room for improvement. It would, therefore, be highly desirable to have a power steering system that incorporated the benefits associated with EPAS designs and further improved communication between the steering column and the torque sensor.

### SUMMARY OF THE INVENTION

It is, therefore, an object of the present invention to provide an EPAS assembly with an improved communication linkage between the steering column shaft and the torque sensor.

In accordance with the objects of the present invention, an EPAS assembly is provided. The EPAS assembly includes a steering input shaft including at least one shaft pin and a pinion shaft including at least one pinion pin. The EPAS assembly further includes a sleeve element including at least one shaft slot and at least one pinion slot. The at least one shaft pin is positioned within the at least one shaft slot. The at least one pinion pin is positioned within the at least one pinion slot. The at least one shaft slot and the at least one pinion slot are oriented such that the relative rotary motion of the steering input shaft and the pinion shaft is converted to linear motion of the sleeve element. The present invention further includes a torque sensor in communication with the sleeve element, the torque measuring the linear motion of the shaft element.

Other objects and features of the present invention will become apparent when viewed in light of the detailed description of the preferred embodiment when taken in conjunction with the attached drawings and appended claims.

### BRIEF DESCRIPTION OF THE DRAWINGS

FIG. 1 is a cross-sectional illustration of an embodiment of an EPAS assembly in accordance with the present invention;

FIG. 2 is a cross-sectional illustration of the embodiment of the EPAS assembly illustrated in FIG. 1, the cross-section taken along the lines 2-2 in the direction of the arrows;

FIG. 3 is a detailed illustration of an EPAS assembly in accordance with the present invention; and

FIG. 4 is a detailed illustration of a pin element for use in the EPAS assembly illustrated in FIG. 3.

### DESCRIPTION OF THE PREFERRED EMBODIMENTS(S)

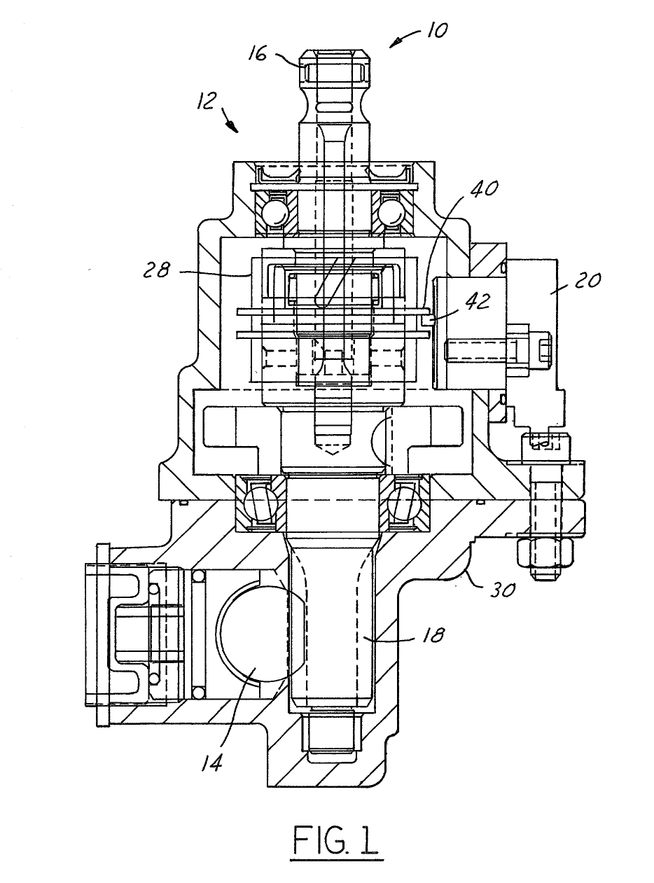

Referring now to FIG. 1, which is an illustration of an EPAS assembly 10 in accordance with the present invention. The EPAS assembly 10 includes a steering linkage 12 in communication with a rack 14. Rotation of the steering linkage 12 induces motion in the rack 14, thereby providing steering control. The use of steering columns 12 and racks 14 are well-known in the art. Although a particular embodiment may be illustrated, a wide variety of individual embodiments will become obvious to one skilled in the art. The steering linkage 12 is comprised of a steering input shaft 16 and a pinion shaft 18.

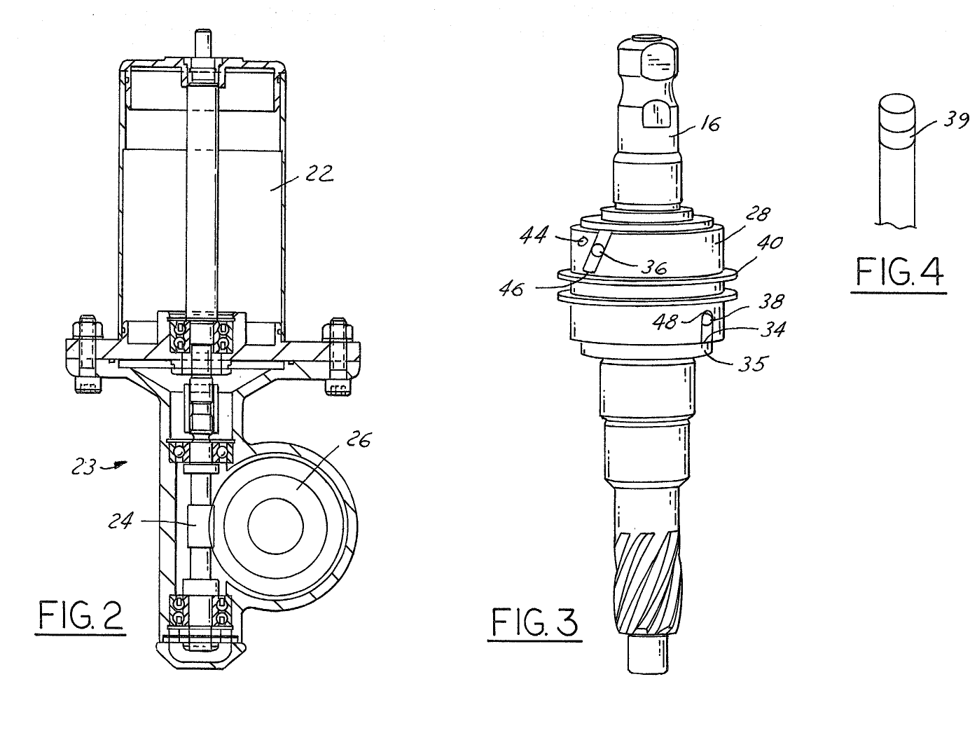

A torque sensor 20 is utilized to measure the torque applied to the input shaft 16. This torque information is utilized by a control motor 22 (see FIG. 2) that in turn provides power assist to the pinion shaft 18. Although the present invention contemplates a variety of drive assemblies 23 for transferring power assist from the motor 22 to the pinion shaft 18, one embodiment, illustrated in FIG. 2, utilizes a worm drive 24 driven by the motor 22. The worm drive 24 is in communication with the worn gear 26 that is, in turn, mounted in communication with the pinion shaft 18. It should be understood that although one particular drive assembly 23 for imparting electric power assist to a steering linkage 12 has been described, a wide variety of modifications and alternatives would be obvious to one skilled in the art.

Although a variety of EPAS assemblies are known in the prior art, the present invention provides a unique and novel approach to the interaction between steering linkage 12 and the torque sensor 20. The steering input shaft 16 and the pinion shaft 18 are not formed integrally as part of a single shaft. Instead, the present invention includes a sleeve 28 that provides communication between the steering input shaft 16 and the pinion shaft 18. The sleeve 28 provides dual functionality to the EPAS assembly 10. The sleeve 28 allows rotation imparted to the steering input shaft 18 to be transmitted to the pinion shaft 18. In addition, however, the sleeve 28 allows rotational differences between steering input shaft 16 and the pinion shaft 18 to be translated into linear motion. This provides a compact and efficient EPAS assembly 10 and can allow for a reduced profile EPAS housing 30 that reduces engine compartment spacing requirements.

Although it is contemplated that a sleeve element 28 may be constructed in a variety of fashions to translate differential rotation between the steering input shaft 16 and the pinion shaft 18 into linear motion, one embodiment is detailed in FIG. 3. The sleeve element 28 includes at least one helical slot 32 and at least one axial slot 34 formed into opposing ends of the sleeve 28. Although the at least one helical slot 32 and at least one axial slot 34 may be formed in a variety of combinations, the EPAS assembly 10 is preferably formed with two helical slots 32 formed in the sleeve 28 180° apart and two axial slots 34 formed in the sleeve 28 180° apart. Additionally, although placement of the helical slots 32 in relation to the axial slot 34 may be varied, one embodiment contemplates placement of the axial slots 34 in a position approximately 90° from the placement of the helical slots 32. Finally, although FIG. 3 illustrates the helical slots 32 as shaft slots 33 providing communication with the steering input shaft 16 and the axial slots 34 as pinion slots 35 providing communication with the pinion shaft 18, it should be understood that these relationships can easily be reversed.

The present invention further includes at least one input shaft pin 36 positioned within the at least one helical slot 32. The input shaft pins 36 can be mounted to the steering input shaft 16 in a variety of fashions. In one embodiment the input shaft pin 36 are pressed into the steering input shaft 16. In other embodiments, however, a variety of alternative attachment methodologies would become obvious to one skilled in the art. Similarly, the present invention includes at least one pinion pin 38 mounted on or pressed into the pinion shaft 18. The pinion pin 38 is positioned within the at least one axial slot 34 and providing communication between the sleeve 28 and the pinion shaft 18. This structural arrangement allows a rotational difference between the input shaft 16 and the pinion shaft 18 to be translated into linear motion of the sleeve 28.

The present invention can further include bearing elements 39 added to the input shaft pins 36 and the pinion pin 38. The use of bearings 39 can be utilized to reduce the friction associated with motion of the pins 36, 38 within the slots 32, 34. This allows smoother linear movement of the sleeve 28. The linear motion of the sleeve 28 is translated into sensed torque by communication between the sleeve element 28 and the torque sensor 20. Although it is contemplated that this communication may be accomplished through a variety of methods, one embodiment contemplates the use of a circumferential guide 40 formed into the sleeve element 28. The circumferential guide 40 engages a tongue 42 formed as a portion of the torque sensor 20. Linear motion of the tongue 42 is translated into a sense torque valued by the torque sensor 20. Additionally, a tongue element 42 can be utilized to provide resistance to linear motion of the sleeve element 28. This allows a minimum value of torque to be applied to the steering input shaft 16 before differential rotation of the steering input shaft 16 and the pinion shaft 18 is realized.

Although the torque profile controlling the differential rotation between the steering input shaft 16 and the pinion shaft 18 may be accomplished through a variety of methods, the described use of the torque sensor 20 in communication with the sleeve element 28 may provide a variety of benefits. One such benefit is that the power assist profile of the EPAS assembly 10 may be easily modified or adjusted through a modification of substitution of the torque sensor 20. This provides a convenient and expedient method of altering the power steering profile in comparison to the complex steering systems often associated with prior EPAS designs. In addition, this may create a flexible EPAS assembly 10 that may be manufactured to be usable in a variety of applications as opposed to single application designs commonly utilized in the industry. It should be understood, however, that although the torque sensor in combination with the sleeve element 28 has been described as controlling the differential rotation between the steering input shaft 16 and the pinion shaft 18 (in relation to torque imparted on the input shaft 16), a variety of other arrangements may be utilized to control the differential rotation between the input shaft 16 and the pinion shaft 18.

It is furthermore contemplated that a variety of the elements comprising the EPAS assembly 10 may be adjusted to modify the functional profile of the EPAS assembly 10. The helical angle 44 of the helical slots 32 may be varied to test the linear travel distance of the sleeve element 28. In addition, helical stops 46 and axial stops 48 may further limit the magnitude of sleeve 28 travel. It is also contemplated that the profile of the circumferential guide 40 may also be modified to create a desired profile for movement of the tongue 42 of the torque sensor 20. Although each of these elements may be modified independently, it is known that the sleeve 28 travel is a function of the magnitude and direction of driver torque, torque sensor 20 resistance, helical and axial stop locations 46, 48, and the helical angle 44 of the helical slot 32 cut into the sleeve 28. Thus, a combination of elements may be modified in concert in order to provide a functional profile of the EPAS assembly 10.

While particular embodiments of the invention have been shown and described, numerous variations and alternative embodiments will occur to those skilled in the art. Accordingly, it is intended that the invention be limited only in terms of the appended claims.

What is claimed is:

1. An EPAS assembly comprising:
a steering input shaft including at least one input shaft pin;
a pinion shaft including at least one pinion pin;
a sleeve element including at least one helical slot and at least one axial slot, said sleeve element in communication with said steering input shaft by way of said at least one input shaft pin positioned within said at least one helical slot, and said sleeve element in communication with said pinion shaft by way of said at least one pinion pin positioned within said at least one axial slot, said sleeve element translating differences in rotation between said steering input shaft and said pinion shaft into linear motion; and
a torque sensor in communication with said sleeve element, said torque sensor actuated by said linear motion of said sleeve element. .

2. An EPAS assembly as described in claim 1, further comprising:
a motor in communication with said torque sensor; and
a drive assembly providing communication between said motor and said pinion shaft.

3. An EPAS assembly as described in claim 2, wherein said drive assembly comprises:
a worm shaft in communication with said motor; and
a worm gear in communication with said pinion shaft.

4. An EPAS assembly as described in claim 1, further comprising:
at least one bearing element positioned on said at least one input shaft pin.

5. An EPAS assembly as described in claim 1, further comprising:
at least one bearing element positioned on said at least one pinion shaft pin.

6. An EPAS assembly as described in claim 1, further comprising:
a circumferential guide element formed onto said sleeve element, said circumferential guide element in communication with a tongue element on said torque sensor.

7. An EPAS assembly as described in claim 1, wherein said torque sensor provides resistance to said differences in rotation.

8. An EPAS assembly as described in claim 1, further comprising:
at least one helical stop, said at least one helical stop limiting movement of said input shaft pin within said at least one helical slot.

9. An EPAS assembly as described in claim 1, further comprising:
at least one axial stop, said at least one axial stop limiting movement of said pinion pin within said at least one axial slot.

10. An EPAS assembly as described in claim 1, wherein said at least one helical slot comprises two helical slots positioned 180 degrees apart.

11. An EPAS assembly as described in claim 1, wherein said at least one axial slot comprises two axial slots positioned 180 degrees apart.

12. An EPAS assembly comprising:
a steering input shaft;
a pinion shaft;
a sleeve element in communication with said steering input shaft and said pinion shaft, said sleeve element translating differences in rotation between said steering input shaft and said pinion shaft into linear motion; and
a torque sensor in communication with said sleeve element, said torque sensor actuated by said linear motion of said sleeve element.

13. An EPAS assembly as described in claim 12, further comprising:
a motor in communication with said torque sensor; and
a drive assembly providing communication between said motor and said pinion shaft.

14. An EPAS assembly as described in claim 12, further comprising:
a circumferential guide element formed onto said sleeve element, said circumferential guide element in communication with a tongue element on said torque sensor.

15. An EPAS assembly as described in claim 12, further comprising:
at least one shaft slot formed into said sleeve element, said at least one helical slot in communication with said steering input shaft by way of at least one input shaft pin mounted to said steering input shaft and positioned within said at least one shaft slot.

16. An EPAS assembly as described in claim 12, further comprising:
at least one pinion slot formed into said sleeve element, said at least one pinion slot in communication with said pinion shaft by way of said at least one pinion pin mounted to said pinion shaft and positioned within said at least one pinion slot.

17. An EPAS assembly as described in claim 12, wherein said torque sensor provides resistance to said differences in rotation.

18. An EPAS assembly as described in claim 15, wherein said at least one shaft slot comprises at least one helical slot and wherein said sleeve element's linear travel is controlled by a helical angle of said at least one helical slot.

19. An EPAS assembly as described in claim 16, wherein said at least one pinion slot comprises at least one axial slot.

20. A method of controlling the amount of power assist provided by an EPAS assembly comprising:
translating differences in rotation between the steering input shaft and a pinion shaft to linear motion through the use of a sleeve element in communication with the steering input shaft and said pinion shaft;
measuring the linear motion of said sleeve element through the use of a torque sensor in communication with said sleeve element; and
delivering power assist to said pinion shaft in relation to the output of said torque sensor.

21. A method of controlling the amount of power assist provided by an EPAS assembly as described in claim 20 further comprising:
resisting said differences in rotation between said steering input shaft and said pinion shaft through the use of said torque sensor.
